(19) United States
(12) Patent Application Publication
(10) Pub. No.: US 2015/0169129 A1
(43) Pub. Date: Jun. 18, 2015

(54) METHOD OF DISPLAYING TOUCH INDICATOR AND ELECTRONIC DEVICE THEREOF

(71) Applicant: Samsung Electronics Co., Ltd., Suwon-si (KR)

(72) Inventors: Jeong-Min PARK, Suwon-si (KR); Pyeong-Gyu JIN, Suwon-si (KR); Sung-Chul PARK, Seoul (KR)

(21) Appl. No.: 14/566,005

(22) Filed: Dec. 10, 2014

(30) Foreign Application Priority Data
Dec. 13, 2013 (KR) 10-2013-0155240

(51) Int. Cl. G06F 3/041; G06F 3/01

(52) U.S. Cl. CPC G06F 3/0416; G06F 3/017

(57) ABSTRACT

A method of displaying a touch indicator and an electronic device thereof are provided. The method includes transmitting an object to be co-produced to another electronic device and sharing the object with the other electronic device, acquiring touch information of the object from a message received from the other electronic device, classifying a surface touch and a hovering touch of the object based on the touch information, and displaying an indicator which may differentiate the surface touch and the hovering touch.

### CROSS-REFERENCE TO RELATED APPLICATION(S)

This application claims the benefit under 35 U.S.C. §119(a) of a Korean patent application filed on Dec. 13, 2013 in the Korean Intellectual Property Office and assigned Serial number 10-2013-0155240, the entire disclosure of which is hereby incorporated by reference.

### TECHNICAL FIELD

The present disclosure relates to a method of displaying a touch indicator and an electronic device thereof.

### BACKGROUND

In general, electronic devices of various types, such as smart phones or tablet Personal Computers (PCs), may perform two-way communication with at least one or more other electronic devices through several communication networks such as a mobile communication network, a Wi-Fi communication network, and a BlueTooth (BT) communication network. For example, a first user having a first electronic device and a second user having a second electronic device may share one object in real time through two-way communication. In addition, the first electronic device may be set to a master terminal and the second electronic device may be set to a slave terminal. Alternatively, the first electronic device may be set to a slave terminal and the second electronic device may be set to a master terminal.

The first user and the second user may perform various object co-production operations in real time, such that the first user edits the shared object using the master terminal and the second user edits the shared object using the slave terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of displaying a touch indicator to acquire object touch information of another electronic device and display an indicator which may differentiate a surface touch and a hovering touch while each of electronic devices of various types, such as smart phones or tablet PCs, co-produces an object with the another electronic device through two-way communication and an electronic device thereof.

In accordance with an aspect of the present disclosure, an operation method of an electronic device is provided. The operation method includes transmitting an object to be co-produced to another electronic device and sharing the object with the other electronic device, acquiring touch information of the object from a message received from the another electronic device, classifying a surface touch and a hovering touch of the object based on the touch information, and displaying an indicator which may differentiate the surface touch and the hovering touch.

In accordance with another aspect of the present disclosure, an electronic device is provided. The electronic device includes a communication module, a touch screen panel configured to detect a surface touch and a hovering touch, and a processor configured to control the communication module and the touch screen panel, wherein the processor transmits an object to be co-produced to another electronic device and shares the object with the another electronic device, acquires touch information of the object from a message received from the other electronic device, classifies a surface touch and a hovering touch of the object based on the touch information, and displays an indicator which may differentiate the surface touch and the hovering touch.

In accordance with another aspect of the present disclosure, a computer readable medium which stores one or more programs including instructions for allowing an electronic device to transmit an object to be co-produced to another electronic device and share the object with the another electronic device, acquire touch information of the object from a message received from the another electronic device, classify a surface touch and a hovering touch of the object based on the touch information, and display an indicator which may differentiate the surface touch and the hovering touch.

In accordance with another aspect of the present disclosure, operation method of editing an object using an electronic device is provided. The method includes displaying at least a part of an object on a touch screen, receiving, from another electronic device, touch information relating to the object, determining, based on the received touch information relating to the object, at least one of a location on the object at which the object is being edited on the other electronic device and a type of input to the object being made on the other electronic device, and displaying an indicator overlaid with the at least the part of the object indicating so as to indicate the at least one of the location on the object at which the object is being edited on the other electronic device and the type of input to the object being made on the other electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating configuration of an electronic device according to an embodiment of the present disclosure;

FIG. 2 is a block diagram illustrating detailed configuration of hardware according to an embodiment of the present disclosure;

FIG. 3 is a block diagram illustrating detailed configuration of a programming module according to an embodiment of the present disclosure;

FIGS. 4A and 4B illustrate a laminated structure of a capacitive type Touch Screen Panel (TSP) according to an embodiment of the present disclosure;

FIGS. 5A and 5B illustrate a surface touch state of a capacitive type TSP according to an embodiment of the present disclosure;

FIG. 6 illustrates a surface touch state and a hovering touch state of a capacitive type TSP according to an embodiment of the present disclosure;

FIG. 7 is a screen illustrating a process of sharing and displaying an object in a plurality of electronic devices according to an embodiment of the present disclosure;

FIG. 8 is a screen illustrating a process of displaying an indicator of a surface touch on an object according to an embodiment of the present disclosure;

FIG. 9 is a screen illustrating a process of displaying an indicator of a hovering touch on an object according to an embodiment of the present disclosure;

FIG. 10 is a flowchart illustrating a method of displaying a touch indicator in an electronic device according to an embodiment of the present disclosure;

FIG. 11 illustrates object co-production information according to an embodiment of the present disclosure;

FIGS. 12A and 12B are screens illustrating a process of displaying an indicator which may differentiate hovering touch depth according to an embodiment of the present disclosure;

FIG. 13 is a screen illustrating a process of dividing and displaying partial objects in a plurality of electronic devices according to an embodiment of the present disclosure;

FIG. 14 is a screen illustrating a process of displaying an indicator of a surface touch on a partial object according to an embodiment of the present disclosure;

FIG. 15 is a screen illustrating a process of displaying an indicator of a hovering touch on a partial object according to an embodiment of the present disclosure;

FIG. 16 is a screen illustrating a process of merging partial objects based on an area according to an embodiment of the present disclosure;

FIG. 17 is a screen illustrating a process of merging partial objects based on an area according to an embodiment of the present disclosure; and

FIG. 18 is a screen illustrating a process of merging partial objects based on a layer according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to various embodiments of the present disclosure may be a device including a communication function. For example, the electronic device may be one or a combination of one or more of various devices, such as a smart phone, a tablet PC, a mobile phone, a video phone, an e-book reader, a desktop PC, a laptop PC, a netbook computer, a Personal Digital Assistant (PDA), a Portable Multimedia Player (PMP), a Moving Picture Experts Group (MPEG) layer 3 (MP3) player, a mobile medical device, an electronic bracelet, an electronic necklace, electronic Appcessories, a camera, a wearable device, an electronic clock, a wristwatch, smart white appliances (e.g., a refrigerator, an air conditioner, a cleaner, a cybot, a TV, a Digital Versatile Disc (DVD) player, an audio, an oven, a microwave oven, a washing machine, an air cleaner, an electronic picture frame, and/or the like), various medical devices (e.g., a Magnetic Resonance Angiography (MRA), a Magnetic Resonance Imaging (MRI), a CT (Computed Tomography), an imaging apparatus, a ultrasonic machine, and/or the like), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, a car infotainment device, electronic equipment for ship (e.g., a navigation device for ship, a gyrocompass, and/or the like), avionics, a security device, electronic clothes, an electronic key, a camcorder, a game console, a Head Mounted Display (HMD), a flat panel display, an electronic album, a part of furniture or a building/structure including a communication function, an electronic board, an electronic signature receiving device, or a projector. It is obvious to a person skilled in the art that the electronic device according to various embodiments of the present disclosure is not limited to the above-described devices.

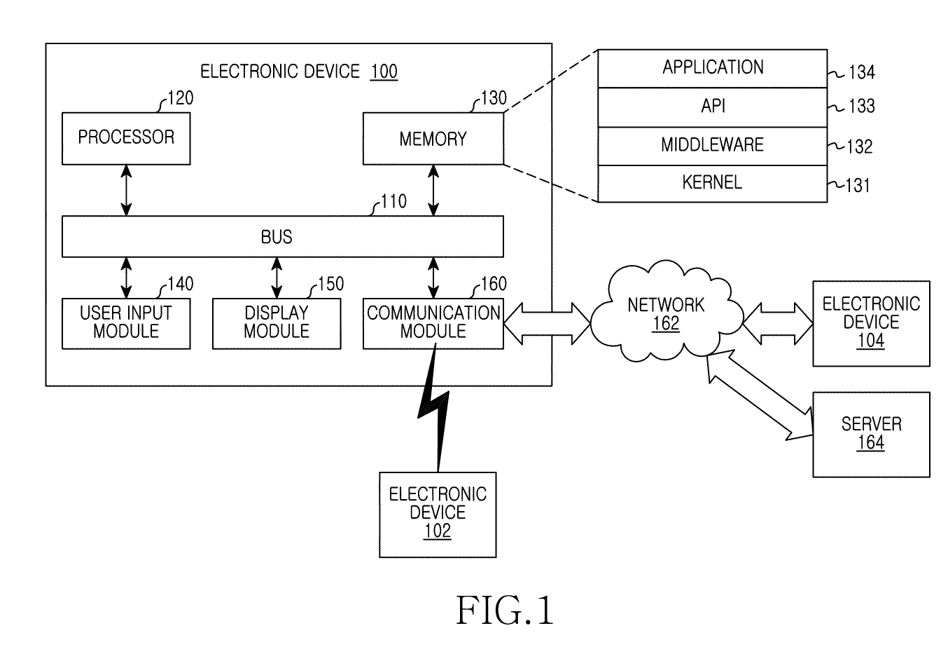

FIG. 1 is a block diagram illustrating configuration of an electronic device according to an embodiment of the present disclosure.

Referring to FIG. 1, the electronic device denoted by 100 may include a bus 110, a processor 120, a memory 130, a user input module 140, a display module 150, and a communication module 160.

The bus 110 may be a circuit which may connect the above-described components with each other and transmit communication (e.g., a control message) between the components.

The processor 120 may receive, for example, commands from the above-described other components (e.g., the memory 130, the user input module 140, the display module 150, the communication module 160, and/or the like) through the bus 110, decode the received commands, and perform calculation or data processing according to the decoded commands.

The memory 130 may store commands or data which are received from the processor 120 or the other components (e.g., the user input module 140, the display module 150, the communication module 160, and/or the like) or are generated by the processor 120 or the other components. The memory 130 may include programming modules such as a kernel 131, a middleware 132, an Application Programming Interface (API) 133, or an application 134. Herein, the above-described respective programming modules may be composed of software, firmware, hardware, or combination of at least two or more of them.

The kernel 131 may control or manage system resources (e.g., the bus 110, the processor 120, or the memory 130, and/or the like) used to execute an operation or function implemented in the other programming modules, for example, the middleware 132, the API 133, or the application 134.

The kernel 131 may provide an interface which may access a separate component of the electronic device 100 in the middleware 132, the API 133, or the application 134 and control or manage the separate component.

The middleware 132 may play a role as a go-between such that the API 133 or the application 134 communicates with the kernel 131 and transmits and receives data with it. In addition, the middleware 132 may perform load balancing for work requests using a method of assigning priority which may use system resources (the bus 110, the processor 120, or the memory 130, and/or the like) of the electronic device 100 to, for example, at least one of the plurality of applications 134, in association with the work requests received from the plurality of applications 134.

The API 133 is an interface in which the application 134 may control a function provided from the kernel 131 or the middleware 132. For example, the API 133 may include at least one interface or function for file control, window control, image processing, or text control.

The user input module 140 may receive, for example, commands or data from the user and transmit the received commands or data to the processor 120 or the memory 130 through the bus 110.

The display module 150 displays videos, images, or data to the user.

The communication module 160 may perform communication between another electronic device 102 and the electronic device 100. The communication module 160 may support a local-area communication protocol (e.g., Wi-Fi, BT, and Near Field Communication (NFC)), or certain network communication 162 (e.g., the Internet, a Local Area Network (LAN), a Wide Area Network (WAN), a telecommunication network, a cellular network, a satellite network, or a Plain Old Telephone Service (POTS), and/or the like). According to various embodiments of the present embodiments, the electronic device 100 may communicate with one or more of the electronic device 102, the electronic device 104, a server 164, and/or the like over the network 162. Each of the other electronic devices 102 and 104 may be the same (e.g., the same type) device as the electronic device 100 or a device (e.g., a different type) which is different from the electronic device 100.

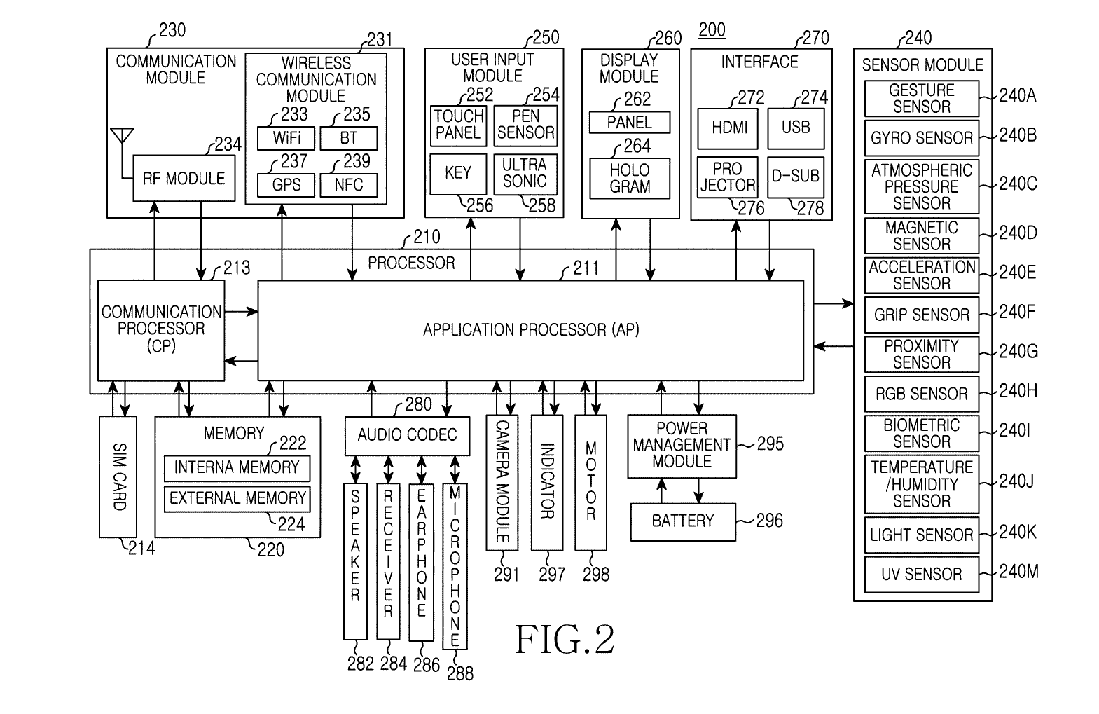

FIG. 2 is a block diagram illustrating detailed configuration of hardware according to an embodiment of the present disclosure.

Referring to FIG. 2, the hardware 200 may be, for example, the electronic device 100 shown in FIG. 1. Referring to FIGS. 1 and 2, the hardware 200 may include one or more processors 210, a Subscriber Identity Module (SIM) card 214, a memory 220, a communication module 230, a sensor module 240, a user input module 250, a display module 260, an interface 270, an audio codec 280, a camera module 291, a power management module 295, a battery 296, an indicator 297, or a motor 298.

The processor 210 (e.g., the processor 120) may include one or more Application Processors (APs) 211 and/or one or more Communication Processors (CPs) 213. The processor 210 may be, for example, the processor 120 shown in FIG. 1. Although the AP 211 and the CP 213 shown in FIG. 2 are shown to be included in the processor 210, they may be included in different IC packages, respectively. In accordance with an embodiment of the present disclosure, the AP 211 and the CP 213 may be included in one IC package.

The AP 211 may execute an OS or an application program, control a plurality of hardware or software components connected thereto, and process and calculate various data including multimedia data. The AP 211 may be implemented as, for example, System on Chip (SoC). In accordance with an embodiment of the present disclosure, the processor 210 may further include a Graphic Processing Unit (GPU) (not shown).

The CP 213 may perform a function for managing a data link in communication between an electronic device (e.g., the electronic device 100) including the hardware 200 and other electronic devices connected with the electronic device through a network and changing a communication protocol. The CP 213 may be implemented as, for example, SoC. In accordance with an embodiment of the present disclosure, the CP 213 may perform at least a part of a multimedia control function. The CP 213 may identify and authenticate, for example, a terminal in a communication network using a SIM (e.g., the SIM card 214). In addition, the CP 213 may provide services, such as a voice communication service, a video communication service, a text message service, or a packet data service, to a user of the hardware 200.

In addition, the CP 213 may control data transmission and reception of the communication module 230. Referring to FIG. 2, components such as the CP 213, the power management module 295, or the memory 220 are shown as components which are separated from the AP 211. However, in accordance with an embodiment of the present disclosure, the AP 211 may be implemented to include at least a part (e.g., the CP 213) of the above-described components.

In accordance with an embodiment of the present disclosure, the AP 211 or the CP 213 may load and process commands or data received from at least one of a non-volatile memory or another component connected thereto to a volatile memory. In addition, the AP 211 or the CP 213 may store data which are received from at least one of other components or are generated by at least one of other components in a non-volatile memory.

The SIM card 214 may be a card implementing a SIM. The SIM card 214 may be inserted into a slot formed in a specific position of the electronic device. The SIM card 214 may include unique identification information (e.g., an Integrated Circuit Card IDentity (ICCID)) or subscriber information (e.g., an International Mobile Subscriber Identity (IMSI)).

The memory 220 may include an internal memory 222 and/or an external memory 224. The memory 220 may be, for example, the memory 130 shown in FIG. 1. The internal memory 222 may include, for example, at least one of a volatile memory (e.g., a Dynamic Random Access Memory (DRAM), a Static RAM (SRAM), or a Synchronous Dynamic RAM (SDRAM), and/or the like) and/or a non-volatile memory (e.g., an One Time Programmable Read Only Memory (OTPROM), a PROM, an erasable PROM (EPROM), an Electrically Erasable PROM (EEPROM), a mask ROM, a flash ROM, a NAND flash memory, a NOR flash memory, and/or the like).

In accordance with an embodiment of the present disclosure, the internal memory 222 may have a type of a Solid State Disk (SSD). The external memory 224 may further include, for example, a Compact Flash (CF) card, a Secure Digital (SD) card, a micro-SD card, a mini-SD card, an extreme Digital (xD) card, or a memory stick, and/or the like.

The communication module 230 may include a wireless communication module 231 or a Radio Frequency (RF) module 234. The communication module 230 may be, for example, the communication module 160 shown in FIG. 1. The wireless communication module 231 may include, for example, a Wi-Fi module 233, a BT module 235, a GPS module 237, an NFC module 239, and/or the like. For example, the wireless communication module 231 may provide a wireless communication function using RFs.

Additionally or alternatively, the wireless communication module 231 may include a network interface (e.g., a LAN card), a modem, and/or the like for connecting the hardware 200 with the network (e.g., the Internet, a LAN, a WAN, a telecommunication network, a cellular network, a satellite network, or a POTS, and/or the like).

The RF module 234 may be in charge of transmitting and receiving data, for example, an RF signal or a called electronic signal. Although it is not shown in FIG. 2 the RF module 234 may include, for example, a transceiver, a Power Amplifier Module (PAM), a frequency filter, or a Low Noise Amplifier (LNA), and/or the like. In addition, the RF module 234 may further include components, for example, conductors or conducting wires, for transmitting and receiving electromagnetic waves on a free space in wireless communication.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green, and Blue (RGB) sensor 240H, a bio-sensor 240I, a temperature/humidity sensor 240J, an illumination sensor 240K, or a Ultra Violet (UV) sensor 240M. The sensor module 240 may measure a physical quantity or detect an operation state of the electronic device, and convert the measured or detected information into an electric signal.

Additionally or alternatively, the sensor module 240 may include, for example, an Electronic-noise (E-nose) sensor (not shown), an ElectroMyoGraphy (EMG) sensor (not shown), an ElectroEncephaloGram (EEG) sensor (not shown), an ElectroCardioGram (ECG) sensor (not shown), or a fingerprint sensor (not shown), and/or the like. The sensor module 240 may further include a control circuit for controlling at least one or more sensors included therein.

The user input module 250 may include a touch panel 252, a (digital) pen sensor 254, a key 256, an ultrasonic input device 258, and/or the like. The user input module 250 may be, for example, the user input module 140 shown in FIG. 1. The touch panel 252 may recognize touch input by, for example, at least one of a capacitive type, a resistive type, an infrared type, an ultrasonic type, or the like.

In addition, the touch panel 252 may further include a controller (not shown). In case of the capacity type, the touch panel 252 may recognize not only direct touch input but also proximity touch input. The touch panel 252 may further include a tactile layer. If the touch panel 252 includes a tactile layer, the touch panel 252 may provide a tactile response to the user.

The (digital) pen sensor 254 may be implemented, for example, using the same or similar method as or to a method of receiving touch input of the user or using a separate sheet for recognition.

The key 256 may be, for example, a keypad or a touch key.

The ultrasonic input device 258 is a device which may detect sound waves using a microphone (e.g., the microphone 288) and verify data in the electronic device through a pen which generates ultrasonic waves. The ultrasonic input device 258 may perform wireless recognition. In accordance with an embodiment of the present disclosure, the hardware 200 may receive input of the user from an external device (e.g., the network 102 of FIG. 1, a computer, or the server 164 of FIG. 1) connected with the communication module 230 using the communication module 230.

The display module 260 may include a panel 262 and/or a hologram 264. The display module 260 may be, for example, the display module 150 shown in FIG. 1. The panel 262 may be, for example, a Liquid Crystal Display (LCD) or an Active Matrix-Organic Light-Emitting Diode (AM-OLED), and/or the like. The panel 262 may be implemented to be, for example, flexible, transparent, or wearable.

The panel 262 and the touch panel 252 may be integrated with each other to constitute one module. The hologram 264 shows stereoscopic images on the air using interference of light. In accordance with an embodiment of the present disclosure, the display module 260 may further include a control circuit for controlling the panel 262 or the hologram 264.

The interface 270 may include, for example, a High Definition Multimedia Interface (HDMI) 272, a Universal Serial Bus (USB) interface 274, a projector 276, or a D-sub (subminiature) interface 278. Additionally or alternatively, the interface 270 may include, for example, a Secure Digital/Multi-Media Card (SD/MMC) interface (not shown) or an Infrared Data Association (IrDA) interface (not shown).

The audio codec 280 may convert voices and electronic signals in a two-way direction. The audio codec 280 may convert, for example, voice information input or output through a speaker 282, a receiver 284, an earphone 286, or the microphone 288.

The camera module 291 may be a device which may capture images and videos. In accordance with an embodiment of the present disclosure, the camera module 291 may include, for example, one or more image sensors (e.g., a front lens or a rear lens) (not shown), an Image Signal Processor (ISP) (not shown), or a flash LED (not shown).

The power management module 295 may manage power of the hardware 200. Although it is not shown in FIG. 2, the power management module 295 may include, for example, a Power Management Integrated Circuit (PMIC), a charger IC, or a battery fuel gauge.

The PMIC may be mounted in, for example, an IC or an SoC semiconductor. A charging method of the power management module 295 may be classified into a wire charging method or a wireless charging method. The charger IC may charge a battery and prevent inflow of over voltage or over current from a charger.

In accordance with an embodiment of the present disclosure, the charger IC may include a charger IC for at least one of the wire charging method or the wireless charging method. The wireless charging method is, for example, a magnetic resonance method, a magnetic induction method, or an electromagnetic wave method. In the wireless charging method, additional circuits, for example, a coil loop, a resonance circuit, a rectifier, and/or the like for wireless charging may be added.

The battery fuel gauge may measure, for example, the remaining capacity of the battery 296, voltage in charging, current, or a temperature. The battery 296 may generate electricity and supply power. For example, the battery 296 may be a rechargeable battery.

The indicator 297 may indicate a specific state, for example, a booting state, a message state, a charging state, and/or the like of the hardware 200 or a part (e.g., the AP 211) of the hardware 200. The motor 298 may convert an electric signal into a mechanical vibration. A Micro Control Unit (MCU) may control the sensor module 240. Although it is not shown in FIG. 2, the hardware 200 may further include a processing device (e.g., a GPU) for supporting a mobile TV. The processing device for supporting the mobile TV may process media data according to, for example, the standard of Digital Multimedia Broadcasting (DMB), Digital Video Broadcasting (DVB), or media flow.

Names of the above-described components of the hardware according to an embodiment of the present disclosure may differ according to kinds of electronic devices. The hardware according to an embodiment of the present disclosure may be configured to include at least one of the above-described components. Some components of the hardware may be omitted or the hardware may further include other additional components. In addition, some of the components of the hardware according to an embodiment of the present disclosure are combined and configured as one entity. Therefore, the one device may equally perform functions of the corresponding components before some of the components are combined.

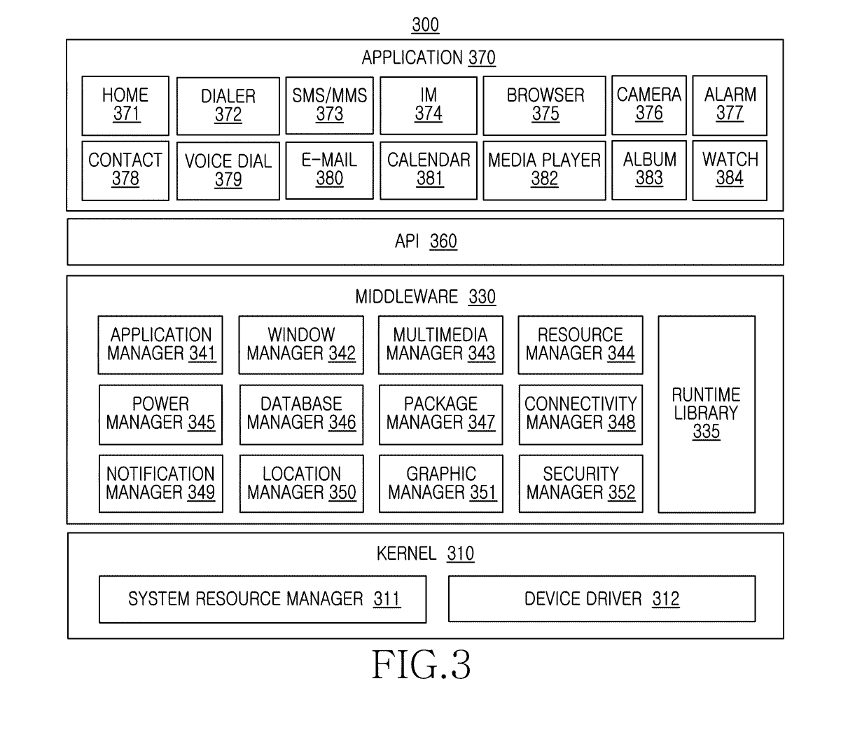

FIG. 3 is a block diagram illustrating detailed configuration of a programming module according to an embodiment of the present disclosure.

Referring to FIG. 3, the programming module denoted by 300 may be included (e.g., stored) in the electronic device 100 (e.g., the memory 130) shown in FIG. 1. At least a part of the programming module 300 may be configured by software, firmware, hardware, or combination of two or more of software, firmware, and hardware.

The programming module 300 may include an OS which is implemented in hardware (e.g., the hardware 200) and controls resources related to an electronic device (e.g., the electronic device 100) or a plurality of applications (e.g., an application 370) executed in the OS. For example, the OS may be Android, iOS, Windows, Symbian, Tizen, Bada, or the like. Referring to FIGS. 1 to 3, the programming module 300 may include a kernel 310, middleware 330, an API 360, or the application 370.

The kernel 310 (e.g., the kernel 131) may include a system resource manager 311 or a device driver 312. The system resource manager 311 may include, for example, a process management unit, a memory management unit, a file system management unit, and/or the like. The system resource manager 311 may control, assign, collect, and/or the like system resources. The device driver 312 may include, for example, a display driver, a camera driver, a Bluetooth driver, a shared memory driver, a USB driver, a keypad driver, a Wi-Fi driver, or an audio driver. In addition, in accordance with an embodiment of the present disclosure, the device driver 312 may include an Inter-Process Communication (IPC) driver (not shown).

The middleware 330 may include a plurality of modules which are previously implemented to provide functions the application 370 needs in common. In addition, the middleware 330 may provide functions through the API 360 such that the application 370 uses limited system resources in the electronic device efficiently.

For example, as shown in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 355 may include, for example, a library module used by a compiler to add a new function through a programming language while the application 370 is executed. In accordance with an embodiment of the present disclosure, the runtime library 355 may perform a function for input and output, memory management, or an arithmetic function.

The application manager 341 may manage, for example, a life cycle of at least one of the applications 370.

The window manager 342 may manage Graphic User Interface (GUI) resources used on a screen of the electronic device.

The multimedia manager 343 may determine a format necessary for reproducing various media files and encode or decode a media file using a codec corresponding to the corresponding format.

The resource manager 344 may manage source codes of at least one of the applications 370, and manage resources of a memory or storage, and/or the like.

The power manager 345 may act with a Basic Input Output System (BIOS), manage a battery or a power source, and provide power information necessary for an operation.

The database manager 346 may perform a management operation to generate, search, or change a database to be used in at least one of the applications 370.

The package manager 347 may manage installation or update of an application distributed by a type of a package file.

The connectivity manager 348 may manage, for example, wireless connection such as Wi-Fi, BT, and/or the like.

The notification manager 349 may display or notify events such as an arrival message, an appointment, and proximity notification by a method which is not disturbed to the user.

The location manager 350 may manage location information of the electronic device.

The graphic manager 351 may manage a graphic effect to be provided to the user or a UI related to the graphic effect.

The security manager 352 may provide all security functions necessary for system security or user authentication, and/or the like.

In accordance with an embodiment of the present disclosure, when the electronic device (e.g., the electronic device 100) has a phone function, the middleware 330 may further include a telephony manager (not shown) for managing a voice or video communication function of the electronic device. The middleware 330 may generate and use a new middleware module through combination of various functions of the above-described internal component modules. The middleware 330 may provide a module which specializes while being classified according to kinds of OSs to provide a differentiated function.

In addition, the middleware 330 may dynamically delete some of old components or add new components. In addition, some of components described in various embodiments of the present disclosure may be omitted, other components may be further added, or components having different names for performing similar functions may be replaced.

The API 360 (e.g., the API 133) as a set of API programming functions may be provided as different components according to OSs. For example, in case of Android or iOS, one API set may be provided while being classified according to platforms. In case of Tizen, for example, two or more API sets may be provided.

The application 370 (e.g., the application 134) may include, for example, a preloaded application or a third party application. At least a part of the programming module 300 may be implemented as instructions stored in computer-readable storage media. One or more processors may perform functions corresponding to the instructions when the instructions are executed by the one or more processors (e.g., the processor 210). The application 370 may be or otherwise include one or more of a home application 371, a dialer application 372, a short messaging service (SMS)/multimedia messaging service (MMS) application 373, an instant messaging (IM) application 374, a browser application 375, a camera application 376, an alarm application 377, a contacts application 378, a voice dial application 379, an email application 380, a calendar application 381, a media player application 382, an album application 383, a clock application 384, and/or the like.

The computer-readable storage media (e.g., a non-transitory computer-readable storage medium) may be, for example, the memory 220 shown in FIG. 2. At least a part of the programming module 300 may be, for example, implemented (e.g., executed) by the processor 210. At least a part of the programming module 300 may include, for example, a module, a program, a routine, sets of instructions, or a process, and/or the like for performing one or more functions.

Names of the components of the programming module (e.g., the programming module 300) according to an embodiment of the present disclosure may differ according to kinds of OSs. In addition, the programming module according to an embodiment of the present disclosure may include at least one or more of components. Some of the components may be omitted. The programming module according to an embodiment of the present disclosure may further include additional other components.

Hereinafter, a description will be given for an operation of the present disclosure in detail with reference to the attached drawings. When it is determined that a detailed description for related well-known functions or constitutions may obscure the subject matter of the present disclosure unnecessarily in describing the present disclosure, the detailed description may be omitted. In addition, terms which will be described later are terms defined in consideration of functions in various embodiments of the present disclosure and may be changed according to intent of a user and operator or custom, and/or the like. Therefore, the definitions may be given based on content throughout the present specification.

Hereinafter, a description will be given in detail for a method of displaying a touch indicator and an electronic device thereof according to various embodiments of the present disclosure. The electronic device such as a smart phone or a tablet PC according to various embodiments of the present disclosure may include a TSP. The TSP may be a capacitive type TSP, and/or the like with strong durability, short response time, and excellent transparency.

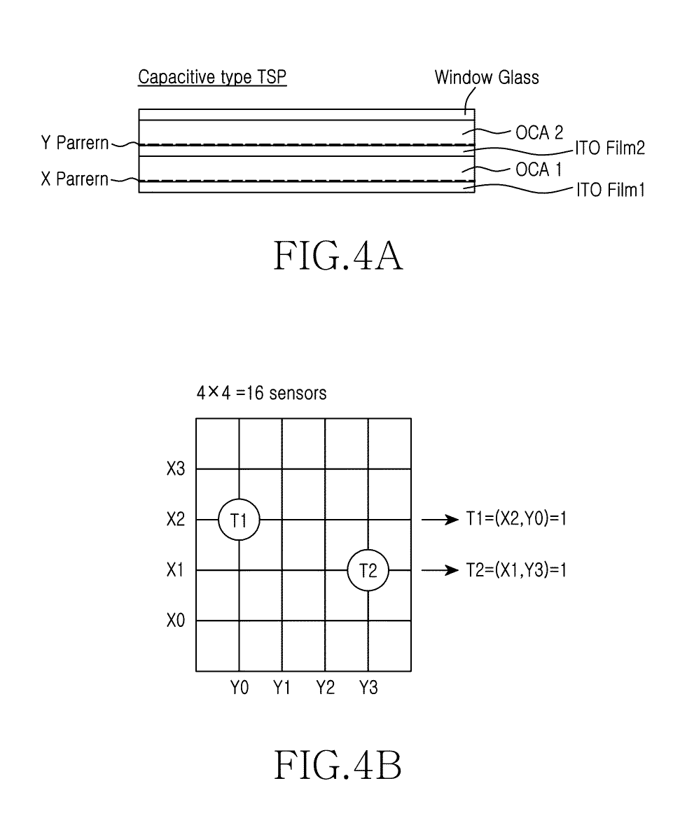

FIGS. 4A and 4B illustrate a laminated structure of a capacitive type TSP according to an embodiment of the present disclosure.

Referring to FIGS. 4A and 4B, the capacitive type TSP has a structure in which an Indium Tin Oxide (ITO) film 1, an Optical Clear Adhesive (OCA) 1, an ITO film 2, an OCA 2, a window glass, and/or the like are laminated in a direction from a lower layer to an upper layer. The OCA 1 and the OCA 2 may be a transparent double-sided tape for bonding the ITO film 1 and the ITO film 2 and bonding the ITO film 2 and the window glass, respectively. The ITO film 1 and the ITO film 2 may be, as a compound of indium and tin oxide, a thin film making a transparent electrode.

A transceiver which transmits a pulse signal may be formed as a lateral X-pattern in a contact surface of the ITO film 1, which comes in contact with the OCA 1. A receiver which receives the pulse signal may be formed as a longitudinal Y-pattern in a contact surface of the ITO film 2, which comes in contact with the OCA 2. As an example, referring to FIG. 4B, in a TSP of 4×4 sensors, a user of the electronic device touches a T1 position with his or her finger, a value of a coordinate (X2, Y0) corresponding to the T1 position may be detected as 1. If the user touches a T2 position, a value of a coordinate (X1, Y3) corresponding to the T2 position may be detected as 1.

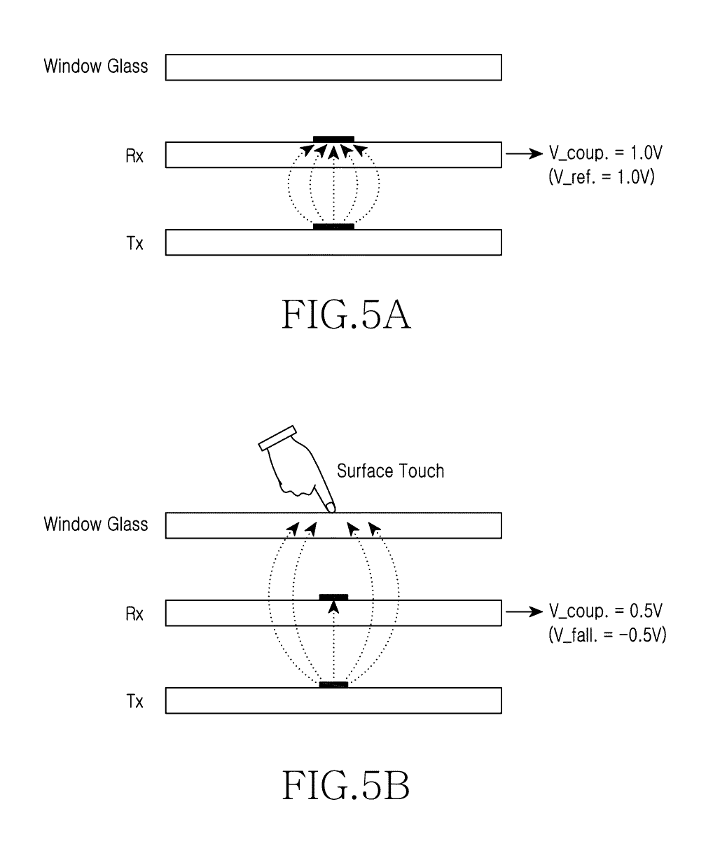

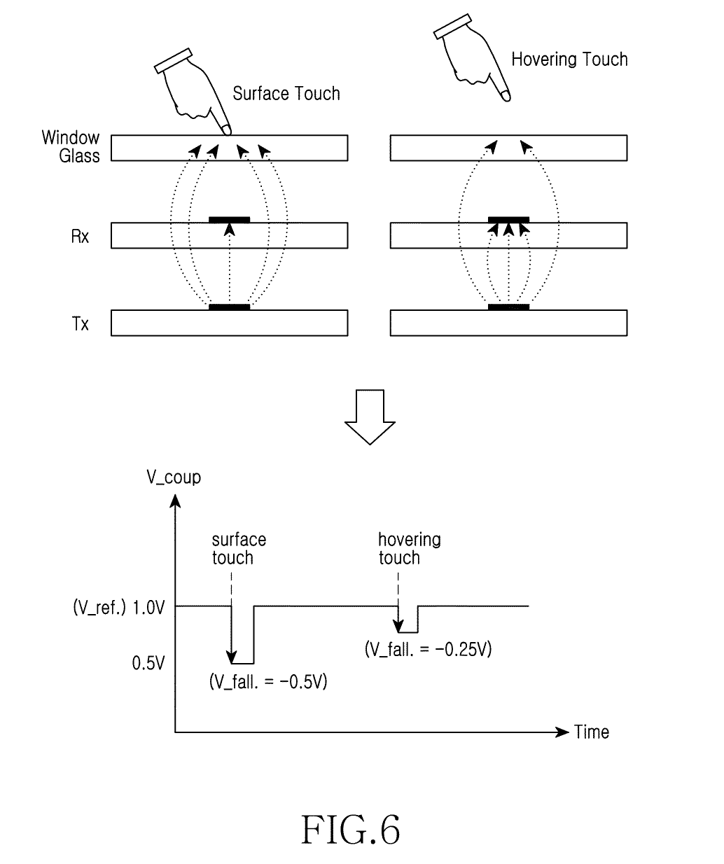

FIGS. 5A and 5B illustrate a surface touch state of a capacitive type TSP according to an embodiment of the present disclosure. FIG. 6 illustrates a surface touch state and a hovering touch state of a capacitive type TSP according to an embodiment of the present disclosure.

Referring to FIGS. 5A and 5B, a user of an electronic device may perform a surface touch for touching a surface of a TSP using the user's finger, pen, and/or the like. In addition, as shown in FIG. 6, the user may move the user's finger or pen to be close (e.g., within 1 cm) to a surface of the TSP and perform a hovering touch by non-contact. The pen may be an electronic pen which may detect a touch of the TSP. The hovering touch may be referred to as various names such as a floating touch, and/or the like.

As shown in FIG. 5A, when there is no touch, all of the pulse signals transmitted from a transceiver Tx of an X pattern are received in a receiver Rx of a Y pattern. As shown in FIG. 5B, when there is a touch of the user, only some of pulse signals transmitted from the transceiver Tx of the X pattern are received in the received Rx of the Y pattern. For example, there is no touch, a coupling voltage (e.g., V_coup=1.0V) between the transceiver Tx and the receiver Rx may be detected as a predetermined reference voltage (e.g., V_ref=1.0V).

In contrast, when there is a surface touch of the user, because some of pulse signals transmitted to the transceiver Tx of the X pattern are induced to the touched finger of the user, only the other is received in the receiver Rx of the Y pattern. A coupling voltage between the transceiver Tx and the receiver Rx may be detected as voltage which is lower than the reference voltage (e.g., V_ref=1.0V). A coupling voltage falling from the reference voltage may be referred to as various names such as a falling coupling voltage (V_fall).

Referring to FIG. 6, an electronic device according to an embodiment of the present disclosure may detect a falling coupling voltage (V_fall.) falling to voltage which is lower than a predetermined reference voltage (e.g., V_ref=1.0V) and detect a surface touch or a hovering touch of the user. For example, when the user performs the surface touch on the TSP, the falling coupling voltage may be detected as −0.5V (V_fall.=−0.5V). In contrast, when the user performs the hovering touch above the TSP in a non-contact state, a falling coupling voltage may be detected as −0.25V (V_fall.=−0.25V).

The electronic device according to an embodiment of the present disclosure may include the components shown in FIG. 2. The processor 210 of the electronic device may control operations of the display module 260, the application processor 211, and/or the like and perform various operations requested by the user. The display module 260, as a TSP, may be, for example, a capacitive type TSP which may detect all of a surface touch and a hovering touch of a finger, an electronic pen, and/or the like of the user or detect only the surface touch.

The processor 210 may set an object co-production mode, control an operation of the communication module 230, perform two-way communication with at least one or more other electronic devices, share an object to be co-produced in real time, according to a request of the user, and/or the like. For example, the object may be content of various types such as drawing, coloring, and writing a document.

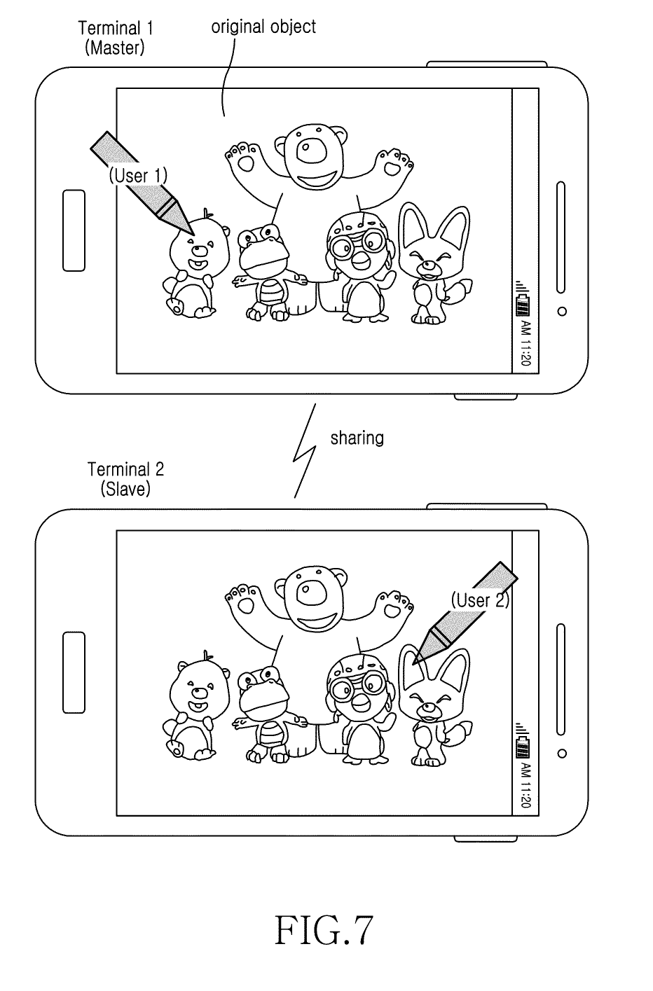

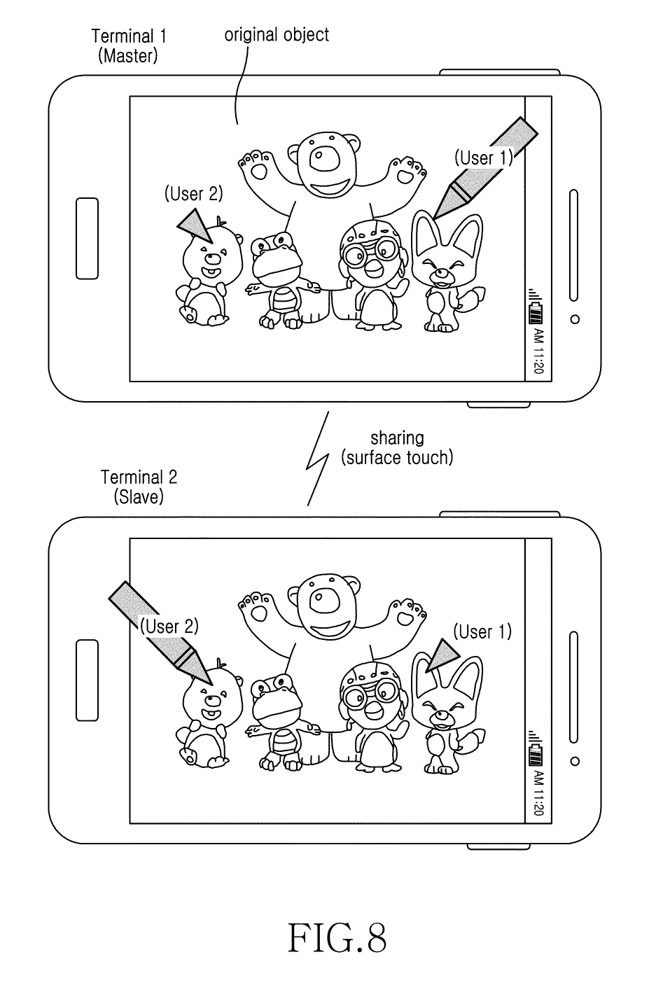

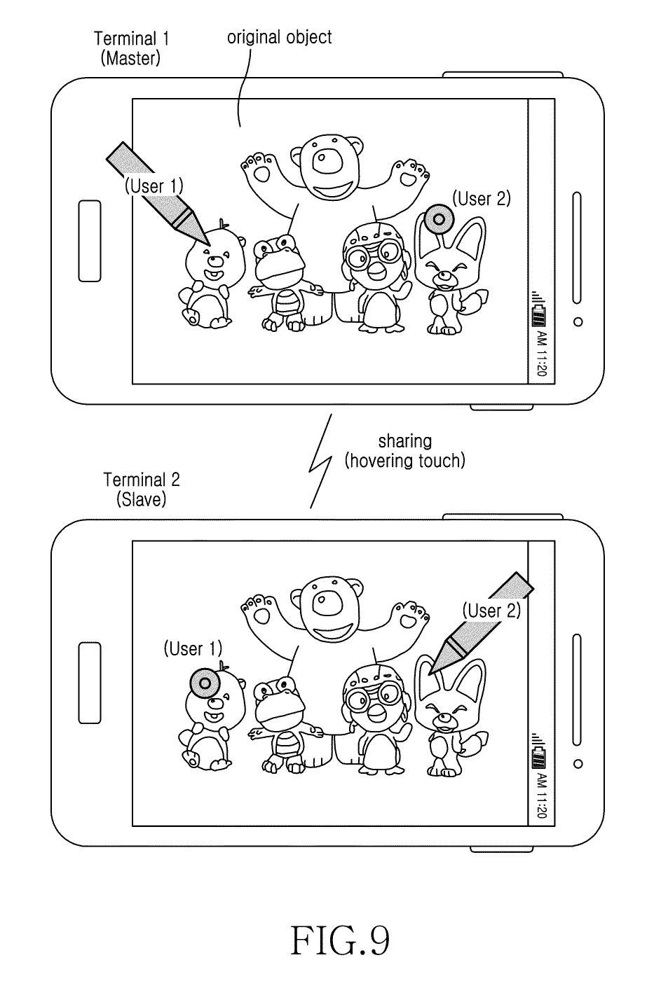

FIG. 7 is a screen illustrating a process of sharing and displaying an object in a plurality of electronic devices according to an embodiment of the present disclosure. FIG. 8 is a screen illustrating a process of displaying an indicator of a surface touch on an object according to an embodiment of the present disclosure. FIG. 9 is a screen illustrating a process of displaying an indicator of a hovering touch on an object according to an embodiment of the present disclosure.

Referring to FIG. 7, a first electronic device such as a smart phone or a tablet PC may be set to a terminal 1 of a master and a second electronic device may be set to a terminal 2 of a slave. The terminal 1 and the terminal 2 may perform two-way communication using several communication networks such as a mobile communication network, a Wi-Fi communication network, a BT communication network, and/or the like.

The terminal 1 transmits an original object to be co-produced to the terminal 2, share the original object with the terminal 2, and co-produces an object in real time with the terminal 2 through two-way communication. For example, a user 1 using the terminal 1 may perform a surface or hovering touch on or above a specific position of an object displayed on a TSP of the terminal 1 and edit the object.

Similarly, a user 2 using the terminal 2 may perform a surface or hovering touch on or above a specific position of an object displayed on a TSP of the terminal 2 and edit the object. The terminal 1 may merge the object edited by the user 1 with the object edited by the user 2, display the merged object, transmit the merged object, and share the merged object with the terminal 2 in real time. For example, when the user 2 performs a surface or hovering touch on or above the TSP, the terminal 2 transmits touch information corresponding to the surface or hovering touch to the terminal 1. The terminal 1 receives the touch information and displays an indicator which may differentiate a surface touch or a hovering touch on the object.

According to various embodiments of the present disclosure, at least one or more of a shape, a color, and luminance of the indicator may be differently displayed to differentiate the surface touch and the hovering touch.

Referring to FIG. 8, when a surface touch is generated on an object of the terminal 2, a triangular indicator may be displayed on an object of the terminal 1 corresponding to a position of the object at which the surface touch is generated. When a surface touch is generated on an object of the terminal 1, a triangular indicator may be displayed on an object of the terminal 2 corresponding to a position of the object at which the surface touch is generated.

In contrast, as shown in FIG. 9, when a hovering touch is generated above an object of the terminal 2, a circular indicator may be displayed on an object of the terminal 1 corresponding to a position of the object at which the hovering touch is generated. When a hovering touch is generated above an object of the terminal 1, a triangular indicator may be displayed on an object of the terminal 2 corresponding to a position of the object at which the hovering touch is generated. Therefore, the user 1 of the terminal 1 and the user 2 of the terminal 2 may predict work intent of a counterpart user, respectively. In addition, the user 1 of the terminal 1 and the user 2 of the terminal 2 may differentiate and recognize a surface or hovering touch of the counterpart user, respectively.

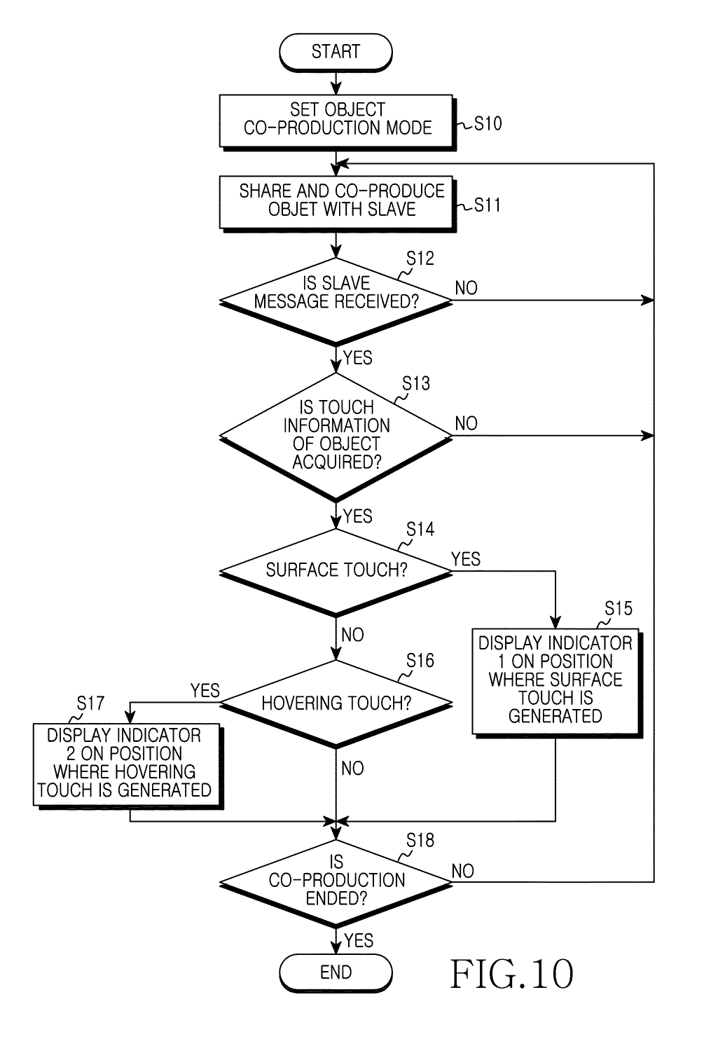

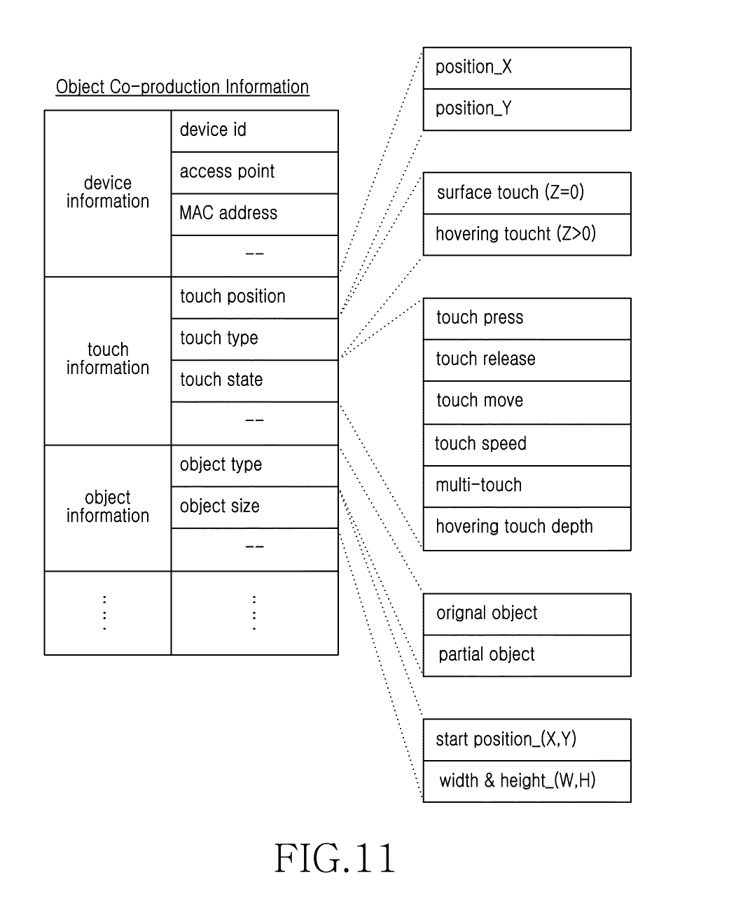

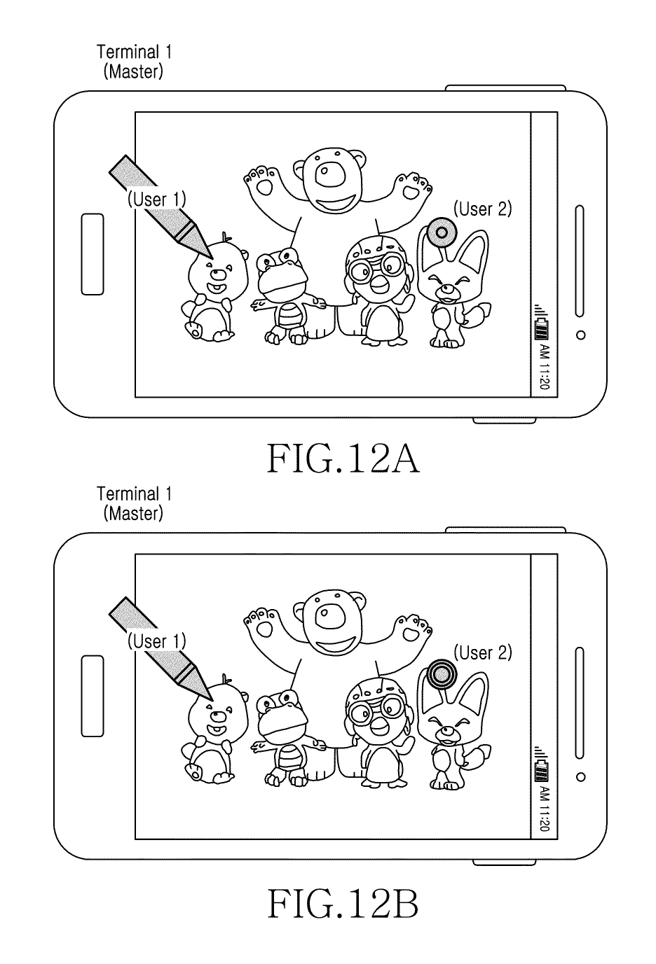

FIG. 10 is a flowchart illustrating a method of displaying a touch indicator in an electronic device according to an embodiment of the present disclosure. FIG. 11 illustrates object co-production information according to an embodiment of the present disclosure. FIGS. 12A and 12B are screens illustrating a process of displaying an indicator which may differentiate hovering touch depth according to an embodiment of the present disclosure.

Referring to FIG. 10, the electronic device shown in FIG. 2 may be set to a terminal 1 of a master. The processor 210 of the terminal 1 may set an object co-production mode according to a request of a user of the electronic device, and/or the like at operation S10, control an operation of the communication module 230, and perform two-way communication with certain another electronic device. The other electronic device may be configured as shown in FIG. 2 and be set to a terminal 2 of a slave.

The processor 210 of the terminal 1 transmits an object to be co-produced to the terminal 2 of the slave, shares the object with the terminal 2 of the slave, and performs an operation co-producing the object in real time through two-way communication at operation S11.

The processor 210 of the terminal 1 receives a message transmitted from the terminal 2 through the communication module 230. The processor 210 of the terminal 1 acquires touch information of an object displayed on the terminal 2 at operation S13 and classifies a surface touch and a hovering touch of the object based on the touch information.

When the touch information is information indicating the surface touch at operation S14, the processor 210 of the terminal 1 displays an indicator 1 on a position of the object at which the surface touch is generated at operation S15. When the touch information is information indicating the hovering touch at operation S16, the processor 210 of the terminal 1 displays an indicator 2 on a position of the object at which the hovering touch is generated at operation S17. The processor 210 of the terminal 1 determines whether the co-production is ended at operation S18. The indicator 1 indicating the surface touch may be, as shown in FIG. 8, a triangular shape. The indicator 2 indicating the hovering touch may be, as shown in FIG. 9, a circular shape.

In addition, one or more of a shape, a color, and luminance of each of the indicators 1 and 2 may be differently displayed. The user may verify the indicator 1 and the indicator 2 and differentiate the surface touch and the hovering touch. The message transmitted from the terminal 2 may include one or more of identification information of the terminal 2, touch information of the object, and type and size information of the object. The information may be referred to as various names such as object co-production information.

The object co-production information may include, for example, as shown in FIG. 11, one or more of a device ID, an access point, and MAC address, which are device information for identifying the terminal 2. The touch information of the object may include one or more of a touch position, a touch type, and a touch state. The touch position is a coordinate (X, Y) value corresponding to an abscissa X-axis and an ordinate Y-axis of an object where a touch is generated. The touch type, as a coordinate (Z) value corresponding to a normal Z-axis of an object at which a touch is generated, may indicate any one of a surface touch and a hovering touch.

The touch position and the touch type may expressed as a coordinate (X, Y, Z) value. If the coordinate (Z) value is zero, the touch type may indicate the surface touch (e.g., Z=0). If the coordinate (Z) value is greater than zero, the touch type may indicate the hovering touch (e.g., Z>0). The touch state may indicate one or more of touch press, touch move, touch release, touch speed, multi-touch, and hovering touch depth. For example, as shown in FIG. 12A, a circular indicator indicating a hovering touch generated above the terminal 2 may be displayed on an object of the terminal 1.

In addition, as shown in FIG. 12B, the indicator indicating the hovering touch may be differently displayed as two circles, three circles, or the like to differentiate hovering touch depth. For example, a hovering touch which is close to a TSP to be less than 0.5 cm may be displayed by an indicator of three circles. A hovering touch which is close to the TSP to be greater than or equal to 0.5 cm may be displayed by an indicator of two circles.

The touch position and the touch type, as mandatory information, are included in touch information of the object. The touch state, as optional information, may not be included in touch information of the object. The type information of the object indicates whether the corresponding object is an original object or a partial object which is at least one of a plurality of partial objects. The size information of the object indicates a size of an original object and a size of a partial object.

For example, the size of the original object indicates a horizontal length and a vertical length. As another example, the size of the partial object may be indicated as a specific start position (start_position_(X, Y)) divided based on the original object and a horizontal width and a vertical height based on the start position. As another example, the size of the partial object may be indicated as a coordinate (X, Y, W, H) value simply.

The processor 210 of the terminal 1 transmits an object on which the first indicator or the second indicator is displayed to the terminal 2 and shares an object co-production process in real time with the terminal 2. In addition, the processor 210 of the terminal 1 may divide an original object to be co-produced into a plurality of partial objects, transmit the partial objects to other electronic devices, and share the partial objects with the other electronic devices.

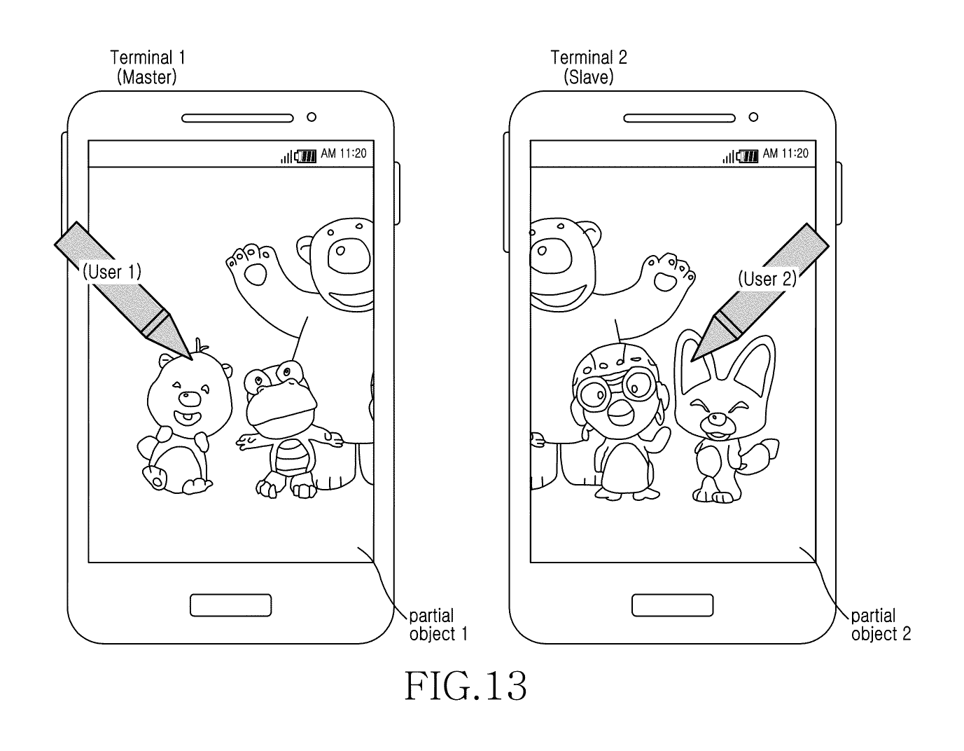

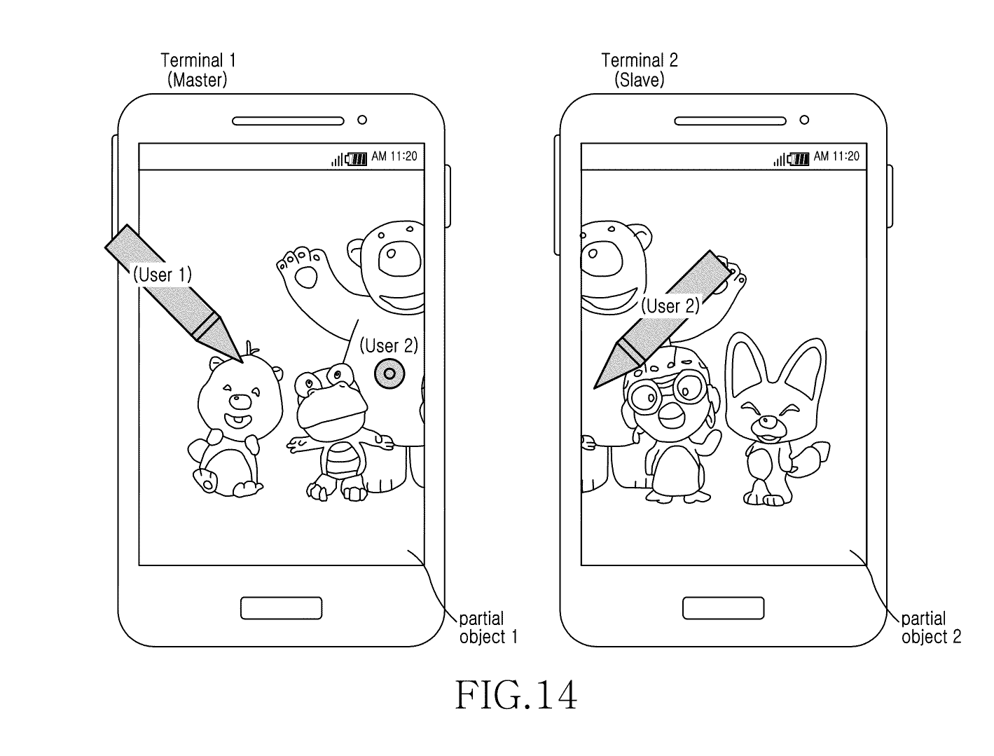

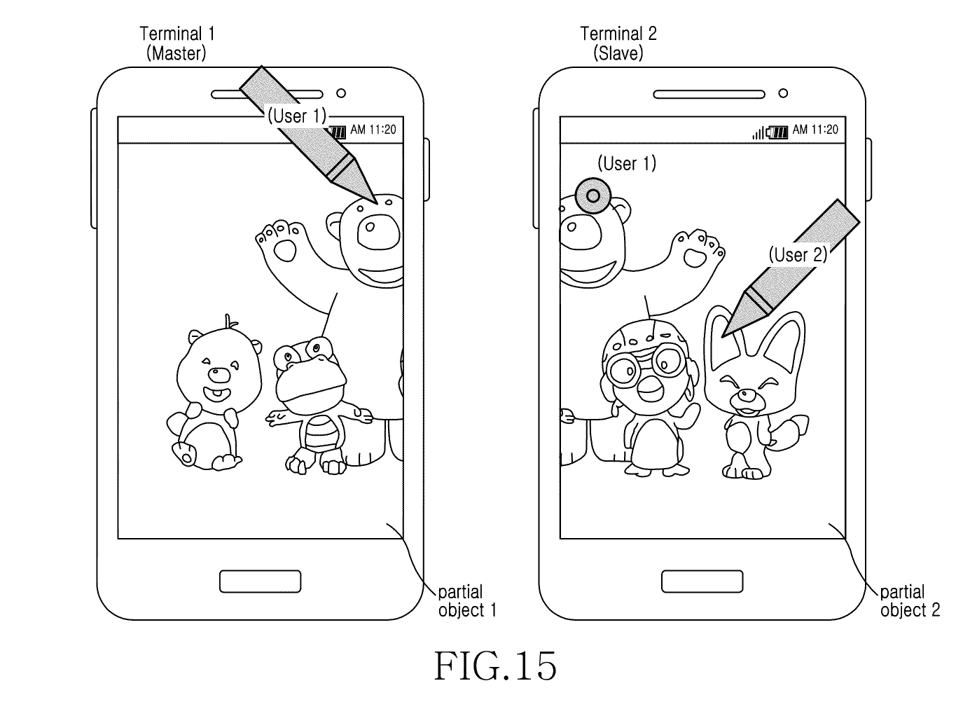

FIG. 13 is a screen illustrating a process of dividing and displaying partial objects in a plurality of electronic devices according to an embodiment of the present disclosure. FIG. 14 is a screen illustrating a process of displaying an indicator of a surface touch on a partial object according to an embodiment of the present disclosure. FIG. 15 is a screen illustrating a process of displaying an indicator of a hovering touch on a partial object according to an embodiment of the present disclosure.

Referring to FIG. 13, the processor 210 of the terminal 1 may divide one original object into a partial object 1 and a partial object 2. The partial object 1 has a left 60% region of the original object and the partial object 2 has a right 60% region of the original object. Therefore, a central 10% region of the original object may be overlapped. When the central 10% region of the original object is overlapped, the processor 210 of the terminal 1 may co-produce a boundary portion between the partial object 1 and the partial object 2 naturally by a seamless type.

The partial object 1 may be displayed on the terminal 1 and the partial object 2 may be displayed on the terminal 2. For example, referring to FIG. 14, when a user 2 using the terminal 2 performs a hovering touch above a region near the leftmost of the partial object 2 using the user's electronic pen (or the like), an indicator indicating the hovering touch may be displayed on a region near the rightmost of the partial object 1 of the terminal 1.

Referring to FIG. 15, when a user 1 using the terminal 1 performs a hovering touch above a region near the rightmost of the partial object 1 using the user's electronic pen (or the like), an indicator indicating the hovering touch may be displayed on a region near the leftmost of the partial object 2 of the terminal 2. If the hovering touch is changed to a surface touch, the indicator is changed to an indicator indicating the surface touch.

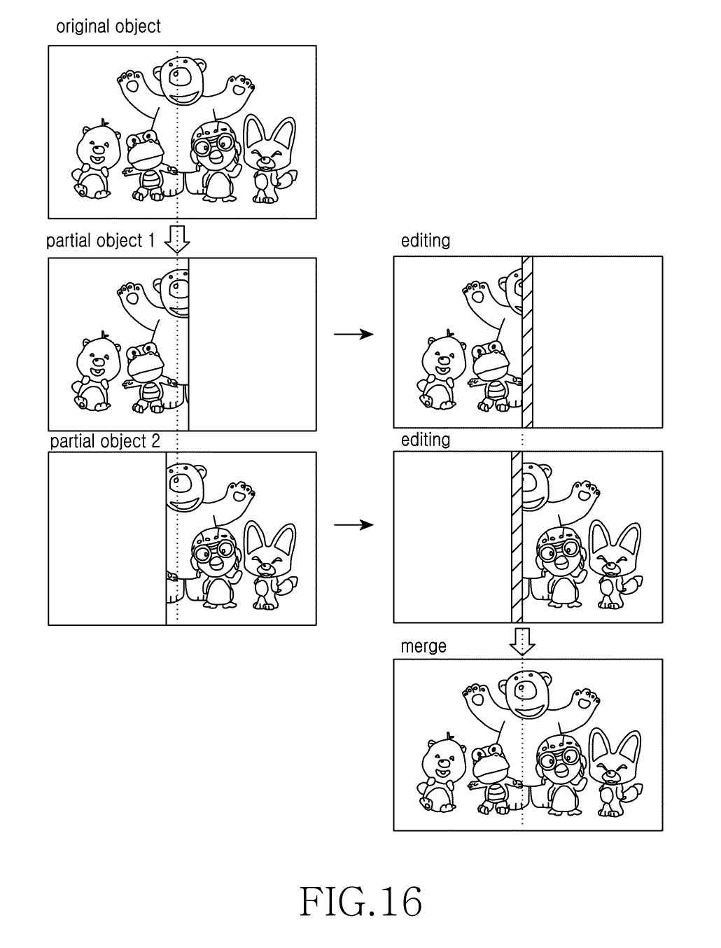

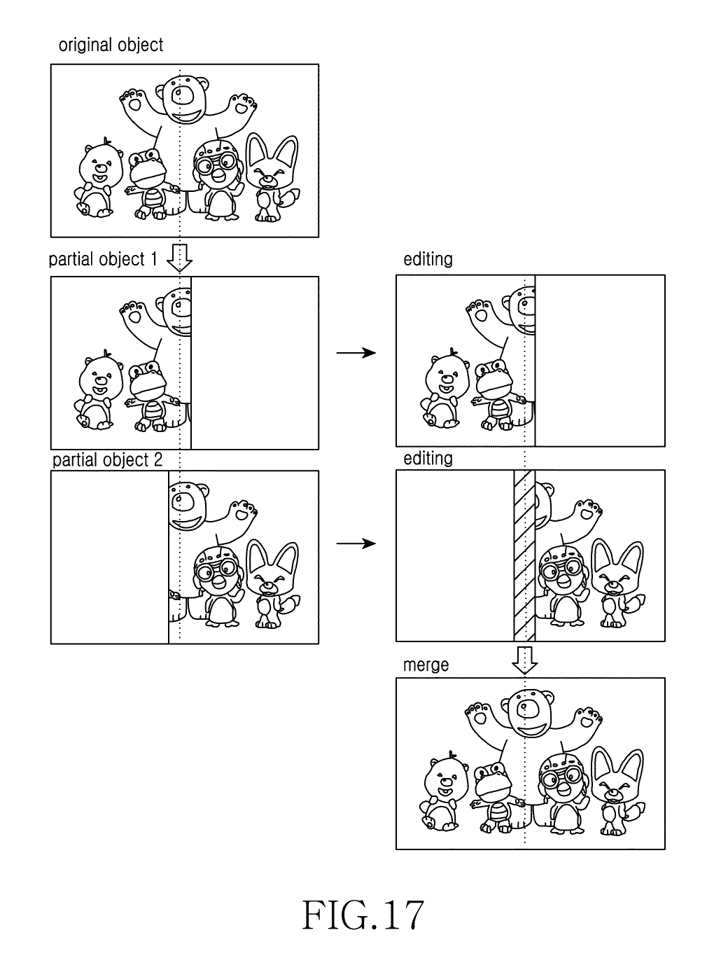

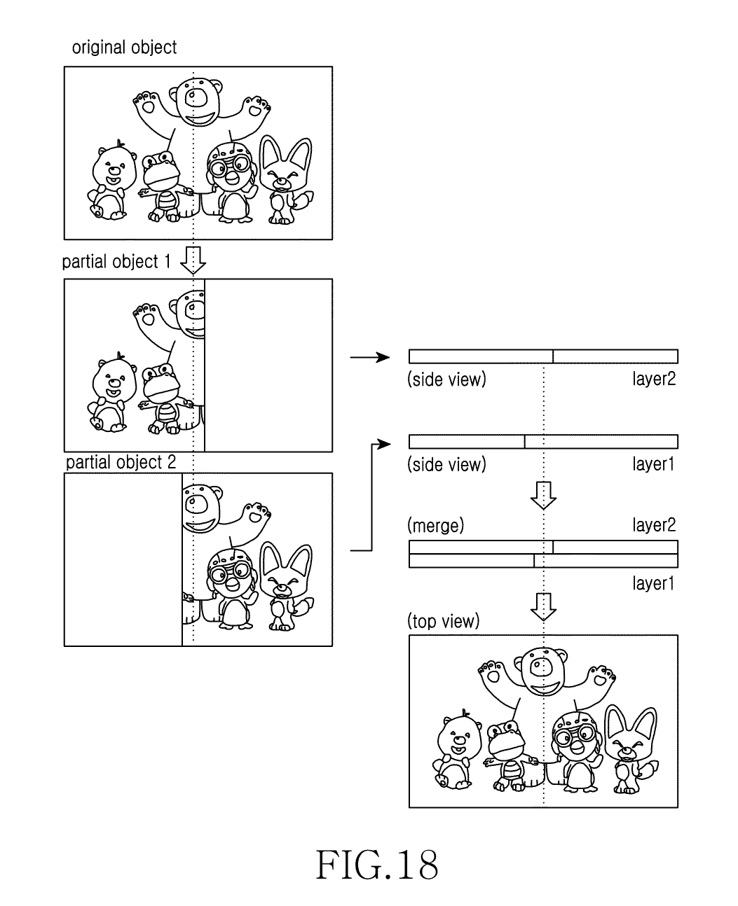

FIGS. 16 and 17 are screens illustrating a process of merging partial objects based on an area according to an embodiment of the present disclosure. FIG. 18 is a screen illustrating a process of merging partial objects based on a layer according to an embodiment of the present disclosure.

The processor 210 of a terminal 1 merges a partial object 1 with a partial object 2 of a terminal 2 and completes an object co-production. For example, the processor 210 of the terminal 1 may merge the partial object 1 with the partial object 2 based on an area or a layer.

Referring to FIG. 16, when merging the partial object 1 with the partial object 2 based on the area, the processor 210 of the terminal 1 may exclude the rightmost 5% region of the partial object 1 and the leftmost 5% region of the partial object 2 from a central 10% region where the partial object 1 and the partial object 2 are overlapped and perform a merging operation based on the area. In addition, referring to FIG. 17, the processor 210 of the terminal 1 may apply a weight to the partial object 1 edited by the terminal 1 of the master, exclude the leftmost 10% region of the partial object 2, and perform a merging operation based on the area.

Referring to FIG. 18, merging the partial object 1 with the partial object 2 based on the area, the processor 210 of the terminal 1 may apply a weight to the partial object 1 edited by the terminal 1 of the master, set the partial object 1 to an upper layer (e.g., a layer 2), set the partial object 2 to a lower layer (e.g., a layer 1), and perform a merging operation based on the layer.

In accordance with various embodiments of the present disclosure, each of electronic device of various types, such as smart phones or tablet PCs, may predict work intent of a user who uses another electronic device by displaying an indicator which may differentiate a surface touch and a hovering touch of the another electronic device while it co-produces an object with the another electronic device through two-way communication. In accordance with various embodiments of the present disclosure, each of the electronic devices may improve efficiency of an object co-production by predicting work intent of a user who uses another electronic device and generating an alarm, a warning, and/or the like when the work intent is improper.

Methods according to claims of the present disclosure or various embodiments described in the specification of the present disclosure may be implemented as hardware, software, or combinational type of the hardware and the software.

When the method is implemented by the software, a non-transitory computer-readable storage medium for storing one or more programs (software modules) may be provided. The one or more programs stored in the non-transitory computer-readable storage medium are configured for being executed by one or more processors in an electronic device.

The one or more programs include instructions for allowing an electronic device to execute the methods according to the claims of the present disclosure and/or the various embodiments described in the specification of the present disclosure. These programs (software modules, software) may be stored in a Random Access Memory (RAM), a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette.

The programs may be stored in a memory configured by combination of some or all such storage devices. In addition, the configured memory may include a plurality of memories. In addition, the programs may stored in an attachable storage device which may access an electronic device through each of communication networks such as the Internet, an intranet, a Local Area Network (LAN), a Wide LAN (WLAN), and a Storage Area Network (SAN) or a communication network configured by combination of them. This storage device may connect to the electronic device through an external port. In addition, a separate storage device on a communication network may connect to a portable electronic device.

In the above-described detailed embodiments of the present disclosure, elements included in the present disclosure were expressed as a single element or a plurality of elements according to the detailed embodiments of the present disclosure. However, the single or plural expression is selected to be suitable for conditions given for convenience of description. The present disclosure is not limited to the single element or the plurality of elements. Although there are elements expressed as a plurality of elements, they may be composed of a single element. Alternatively, although there is an element expressed as a single element, the element may be composed of a plurality of elements.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An operation method of an electronic device, the operation method comprising:
transmitting an object to be co-produced to another electronic device and sharing the object with the another electronic device;
acquiring touch information of the object from a message received from the other electronic device;
classifying a surface touch and a hovering touch of the object based on the touch information; and
displaying an indicator which may differentiate the surface touch and the hovering touch.

2. The method of claim 1, wherein the sharing of the object with the other electronic device comprises dividing the object to be co-produced into a plurality of partial objects, transmitting any one of the plurality of partial objects to the other electronic device, and sharing the one of the plurality of partial objects with the other electronic device.

3. The method of claim 1, wherein the message includes one or more of identification information of the other electronic device, touch information of the object, and type and size information of the object.

4. The method of claim 3, wherein the identification information of the other electronic device includes one or more of a device ID, an access point, and a MAC address.

5. The method of claim 3, wherein the touch information of the object includes one or more of a touch position, a touch type, and a touch state.

6. The method of claim 5, wherein the touch position is a coordinate value (X, Y) corresponding to an abscissa X-axis and an ordinate Y-axis of the object, and
wherein the touch type, as a coordinate value (Z) corresponding to a normal Z-axis of the object, indicates any one of a surface touch and a hovering touch.

7. The method of claim 6, wherein the touch position and the touch type are expressed as a coordinate value (X, Y, Z),
wherein the touch type indicates the surface touch when the coordinate value (Z) is zero, and
wherein the touch type indicates the hovering touch when the coordinate value (Z) is greater than zero.

8. The method of claim 5, wherein the touch state includes one or more of a touch press, a touch move, a touch release, a touch speed, a multi-touch, and a hovering touch depth.

9. The method of claim 1, wherein the displaying of the indicator comprises differently displaying one or more of a shape, a color, and luminance of the indicator which may differentiate the surface touch and the hovering touch.

10. The method of claim 1, further comprising:
transmitting an object on which the indicator is displayed to the another electronic device and sharing the object with the another electronic device.

11. An electronic device comprising:
a communication module;
a touch screen panel configured to detect a surface touch and a hovering touch; and
a processor configured to control the communication module and the touch screen panel,
wherein the processor transmits an object to be co-produced to another electronic device and shares the object with the other electronic device, acquires touch information of the object from a message received from the another electronic device, classifies a surface touch and a hovering touch of the object based on the touch information, and displays an indicator which may differentiate the surface touch and the hovering touch.

12. The electronic device of claim 11, wherein the processor divides the object to be co-produced into a plurality of partial objects, transmits any one of the plurality of partial objects to the other electronic device, and shares the one of the plurality of partial objects with the other electronic device.

13. The electronic device of claim 11, wherein the message includes one or more of identification information of the other electronic device, touch information of the object, and type and size information of the object.

14. The electronic device of claim 13, wherein the identification information of the other electronic device includes one or more of a device ID, an access point, and a MAC address.

15. The electronic device of claim 13, wherein the touch information of the object includes one or more of a touch position, a touch type, and a touch state.

16. The electronic device of claim 15, wherein the touch position is a coordinate value (X, Y) corresponding to an abscissa X-axis and an ordinate Y-axis of the object, and
wherein the touch type, as a coordinate value (Z) corresponding to a normal Z-axis of the object, indicates any one of a surface touch and a hovering touch.

17. The electronic device of claim 16 wherein the touch position and the touch type are expressed as a coordinate value (X, Y, Z),
wherein the touch type indicates the surface touch when the coordinate value (Z) is zero, and
wherein the touch type indicates the hovering touch when the coordinate value (Z) is greater than zero.

18. The electronic device of claim 15, wherein the touch state includes one or more of a touch press, a touch move, a touch release, a touch speed, a multi-touch, and a hovering touch depth.

19. The electronic device of claim 11, wherein the processor differently displays one or more of a shape, a color, and luminance of the indicator which may differentiate the surface touch and the hovering touch.

20. A computer-readable medium storing one or more programs comprising instructions for allowing an electronic device to perform the method of claim 1, when the instructions will be executed by the electronic device.
